(19) United States
(12) Patent Application Publication
(10) Pub. No.: US 2017/0080745 A1
(43) Pub. Date: Mar. 23, 2017

(54) Animal Skull Mount Clip System and Method of Use

(71) Applicant: John Nobi, Stevensville, MT (US)

(72) Inventor: John Nobi, Stevensville, MT (US)

(21) Appl. No.: 15/268,227

(22) Filed: Sep. 16, 2016

Related U.S. Application Data
(60) Provisional application No. 62/220,445, filed on Sep. 18, 2015.

(51) Int. Cl. B44C 5/02

(52) U.S. Cl. CPC B44C 5/02

(57) ABSTRACT

An animal skull mount clip system comprising of a clip with flexible legs extending from a base having a hole, where the legs are inserted into the brain cavity of an animal skull through the foramen magnum by flexing the legs together to clear the foramen magnum before expanding back to their original position, thereby securing the clip within the animal skull and allowing the skull to be attached to a mounting surface by placement of the clip and skull over a mounting stud.

### CROSS-REFERENCE TO RELATED APPLICATIONS

This application claims the benefit of U.S. Provisional Application No. 62/220,445 filed Sep. 18, 2015, the disclosure of which is incorporated herein by reference.

### FIELD OF THE INVENTION

The present invention relates to an animal skull mount clip system that is inserted into the foramen magnum of an animal skull and is formed to grasp the inside of the skull in the brain cavity, and then press fit on a mounting stud for placement on a wall, plaque or other mounting surface.

### BACKGROUND OF THE INVENTION

Taxidermists use various techniques to mount hunting trophies to a wall or plaque. Some techniques simply use a metal or wood hanger with a hook, wherein the skull simply sits on the hook. Another method uses a “molly” bolt that is inserted into the back of the skull and expanded. Another method involves packing the brain cavity with fill material and inserting a dowel into the cavity through the foramen magnum, which can then be attached to a plaque. Another common method simply involves using screws driven through a plaque and then directly into the bones of the skull.

While all these methods are workable, they all have drawbacks, such as possible damage to the skull, skull movement on the mount, inability to easily remove the trophy from the mount, and excessive time involved to properly set up the mount. Therefore, an improved mounting device to eliminate those drawbacks is desirable. The present invention is simple to use, provides for solid mounting, saves time and money, can attach to most surfaces, is esthetically pleasing having no unsightly screws or dowels or hook components, and will not harm the animal skull.

### SUMMARY OF THE INVENTION

The invention comprises a clip system that is inserted into the brain cavity through the spinal cord opening (foramen magnum). The system is formed from a piece of suitable material of sufficient thickness to allow for bends and curves and having the ability to return to the original shape after deflection needed for insertion into the brain cavity, such as spring steel. The system may also be formed to its final shape through use of molds or casts, and utilize materials such as plastics and carbon fiber. The system has a center base and a front leg and rear leg extending away from the base. The legs have widths smaller than the size of the opening of the skull's foramen magnum. The legs are formed such that they grasp the inside of the skull at both the front and the rear of the brain cavity. The system is prevented from falling into the skull by having the base sized larger than the opening of the foramen magnum. The front leg has a narrow section proximate to the base that allows the leg to be positioned at the anterior aspect of the foramen magnum. The narrow section of the leg has two reverse bends that positions the front leg above the base. The narrow section of the front leg transitions to a wide section having a rounded end. The wide section of the front leg is curved downward and away from the base to allow for positioning inside the brain cavity and for pressing against the skull adjacent to the anterior aspect of the foramen magnum. The rear leg has a uniform width that is wider than the narrow section of the front leg, but narrower than the wide section of the front leg. The rear leg has two smooth radius reverse bends making the clip extend away from the base generally perpendicular to the base and allows the rear leg to pass between projections in the brain cavity proximate to the posterior aspect of the foramen magnum, which prevents the clip from rotating in the skull. The base has a hexagonal hole with slots extending outward from each vertex, which then receives a stud having a top and bottom end for a snug slip fit similar to a “push nut.” The hole in the base can be other configurations such as round, square or other multisided shapes. The stud can be any shape desired and can be mounted to a plaque or wall by utilizing a screw through the mounting surface to the bottom end of the stud having female threads. The stud is of a length that allows it to hold the front and rear legs in position in the animal skull when the stud is pushed through the base of the clip.

### BRIEF DESCRIPTION OF THE DRAWINGS

FIG. 1 is a top view of the embodiment of the mounting system shown before the front and rear legs are formed for placement in the animal skull.

FIG. 2 is a side view of the embodiment showing the legs formed for placement in the skull and showing the mounting stud, mounting surface, and screw for attaching the stud to the mounting surface.

FIG. 3 is a perspective view of the embodiment.

FIG. 4 is a perspective view showing the embodiment secured to an animal skull and a mounting surface.

### DESCRIPTION OF THE PREFERRED EMBODIMENT

Although only one embodiment is explained in detail, it is to be understood as an illustration only, and not intended to limit the invention in its scope. Also, in describing the embodiment specific terminology may be used, but it should be understood that specific terms include all technical equivalents that operate in similar manners to accomplish similar purposes.

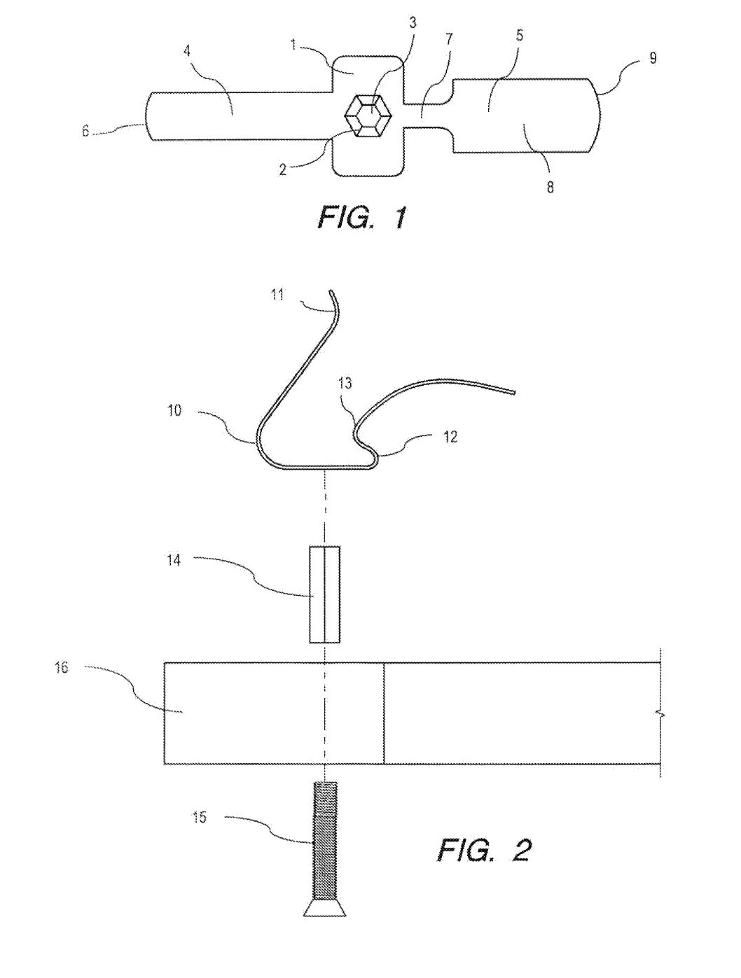

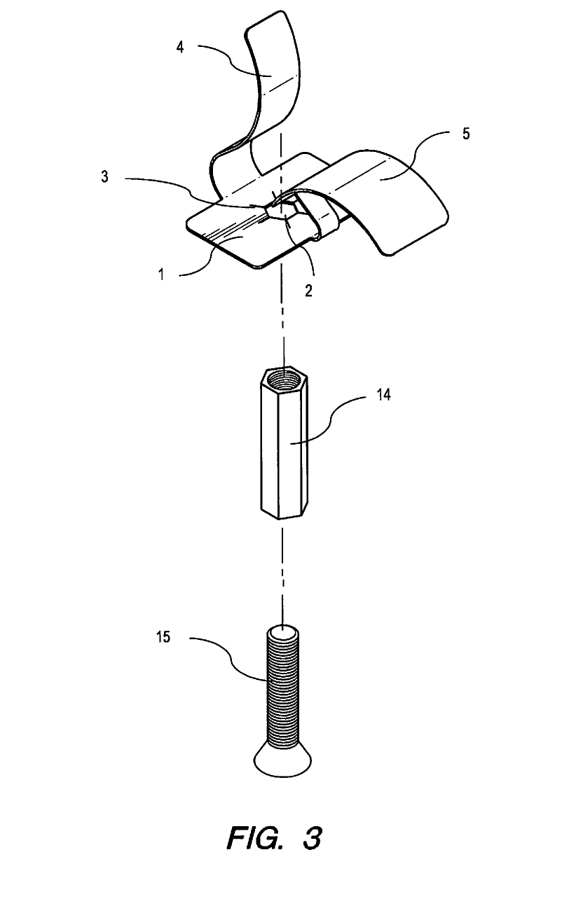

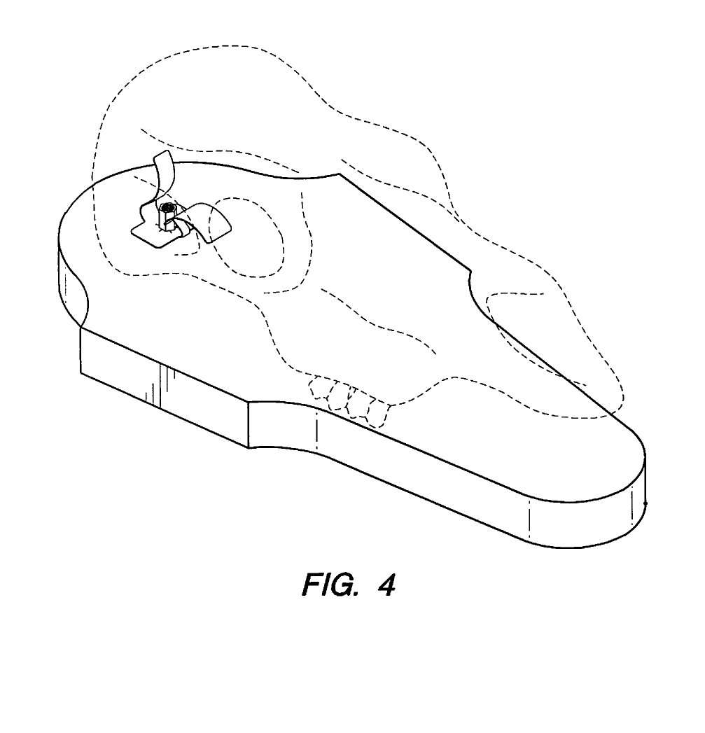

With reference to the drawings, a preferred embodiment of this invention is illustrated in FIGS. 1-4. The system generally comprises a base plate 1, having a center hexagonal hole 2, with slots cut outward from the hexagon vertices 3, a rear leg 4 and a front leg 5. The rear leg has a uniform width sized to enter the foramen magnum of a skull and has a rounded end 6. Said leg has a first reverse bend 10 proximate to the base plate and transitions to a second reverse bend 11 proximate to the end of the leg, thereby positioning the rear leg generally above and extending away from the base plate 1 and curved outward to press on the skull at the rear of the brain cavity. The front leg 5 has a narrow section 7 adjacent to the base plate 1 and a wide section 8 sized to enter the foramen magnum of a skull and to press against the skull interior proximate to the anterior aspect of the foramen magnum, and having a rounded end 9. The narrow section of the front leg 7 has a first reverse bend 12 proximate to the base and a second reverse bend 13 proximate to the wide section of the front leg, which brings the leg above the base before the wide section extends away from the base with a smooth radius-downward curvature. The hexagonal hole 2, receives a hexagonal stud 14 having a top and bottom end. The bottom end has female threads to receive a screw 15 for attachment to a mounting surface 16 such as a plaque or wall. The stud acts to keep the legs in place in the brain cavity after it is pressed through the hole in the base plate.

I claim:

1. An animal skull mount clip system comprising;
A base plate with a mounting hole;
A mounting stud for connection to a mounting surface, wherein the mounting stud is sized to fit within the base plate mounting hole;
A plurality of legs connected to the base plate and sized to fit into the foramen magnum of an animal skull, wherein the legs can be inwardly squeezed relative to each other for simultaneous insertion into the foramen magnum before returning to their original positions within the brain cavity of the animal skull.

2. An animal skull mount clip system comprising;
A base plate with a mounting hole;
A mounting stud for connection to a mounting surface, wherein the mounting stud is sized to fit within the base plate mounting hole;
A front leg connected to the base plate sized to fit into the foramen magnum of an animal skull;
A rear leg connected to the base plate sized to fit into the foramen magnum of an animal skull.

3. The animal skull mount clip system of claim 2, wherein the base plate has a width larger than the opening of the foramen magnum of an animal skull.

4. The animal skull mount clip system of claim 3, wherein the front leg has a narrow section and a wide section, with the narrow section adjacent to the base plate and having of a length sufficient to allow a first reverse bend proximate to the base plate and a second reverse bend proximate to the wide section.

5. The animal skull mount clip system of claim 4, wherein the wide section of the front leg is curved downward relative to the base plate.

6. The animal skull mount clip system of claim 5, wherein the rear leg has a fixed width that is wider than the narrow section of the front leg, but narrower than the wide section of the front leg, and wherein the rear leg has a first reverse bend proximate to the base plate and a second reverse bend proximate to the end of the front leg.

7. The animal skull mount clip system of claim 6, wherein the ends of the front leg and rear leg are rounded.

8. The animal skull mount clip system of claim 7, wherein the mounting stud is of sufficient length to pass beyond the second reverse bend of the narrow section of the front leg.

9. The animal skull mount clip system of claim 8, wherein the base plate, front leg and rear leg are made from spring steel.

10. The animal skull mount clip system of claim 9, wherein the base plate mounting hole is hexagonal with slots cut outward from the hexagon vertices.

11. The animal skull mount clip system of claim 10, wherein the mounting stud is hexagonal and has female threads at one or more ends to receive a screw for attaching to a mounting surface.

12. The animal skull mount clip system of claim 8, wherein the base plate mounting hole is square with slots cut longitudinal outward from the vertices.

13. The animal skull mount clip system of claim 12, wherein the mounting stud is square and has female threads at one or more ends to receive a screw for attaching to a mounting surface.

14. A method of mounting an animal skull to a mounting surface comprising:
Placement of a skull mount clip into the brain cavity of an animal skull through the skull's foramen magnum, wherein the clip has a base having a stud hole proximate to the foramen magnum;
Placement of a stud on a mounting surface;
Positioning and securing the animal skull on the mounting surface by fitting the pre-positioned clip over the stud on the mounting surface.

15. The method of claim 14, wherein the placement of the skull mount clip is performed by squeezing a plurality of flexible legs extending away from the base toward one another and thereby allowing all the legs to pass through the foramen magnum before springing back to their original positions and thereby securing the skull mount clip within the animal skull.

16. The method of claim 15, wherein the fitting of the prepositioned clip over the stud causes the stud to extend between the plurality of flexible legs and acts to keep the legs from squeezing toward one another after placement within the skull.
